(19) United States
(12) Patent Application Publication
(10) Pub. No.: US 2024/0089415 A1
(43) Pub. Date: Mar. 14, 2024

(54) INFORMATION PROCESSING APPARATUS, INFORMATION PROCESSING METHOD, COMPUTER-READABLE MEDIUM, AND INFORMATION PROCESSING SYSTEM

(71) Applicant: NEC Corporation, Minato-ku, Tokyo (JP)

(72) Inventor: Ryoutarou SAKA, Tokyo (JP)

(73) Assignee: NEC Corporation, Minato-ku, Tokyo (JP)

(21) Appl. No.: 18/270,993

(22) PCT Filed: Dec. 28, 2021
(86) PCT No.: PCT/JP2021/048913

§ 371 Date: Jul. 5, 2023

(30) Foreign Application Priority Data
Mar. 30, 2021 (JP) 2021-056702

(51) Int. Cl. H04N 7/18; H04N 5/77; H04N 23/611

(52) U.S. Cl. CPC H04N 7/188; H04N 5/77; H04N 23/611

(57) ABSTRACT

An information processing apparatus (10) includes: an acquisition unit (11) that acquires information indicating an event detected based on an image captured by an imaging apparatus (20); a determination unit (12) that determines to start recording of the image when the event is detected at a first point of time, to continue the recording when the event is continuously detected within a first period from the first point of time, and to stop the recording when the event is continuously detected in a case of exceeding the first period from the first point of time; and a recording control unit (13) that controls a start and an end of the recording based on a result determined by the determination unit.

### TECHNICAL FIELD

The present disclosure relates to an information processing apparatus, an information processing method, a program, and an information processing system.

### BACKGROUND ART

A monitoring system has been known that records and stores images captured by a monitoring camera. Patent Literature 1 discloses a technique in which recording is performed for a predetermined time when a trigger occurs in a monitoring system that records image information about a passenger on a rear seat of a taxi.

### CITATION LIST

### Patent Literature

Patent Literature 1: Japanese Unexamined Patent Application Publication No. 2009-272738

### SUMMARY OF INVENTION

### Technical Problem

However, the technique disclosed in Patent Literature 1 has a problem that the volume of recording data increases in a situation where a trigger continues to occur. The reason is that recording is performed for a predetermined time when a trigger occurs and thus the recording is continued while the trigger continues.

An object of the present disclosure is to provide an information processing apparatus, an information processing method, a program, and an information processing system that can appropriately reduce the volume of recording data in view of the above-described problem.

### Solution to Problem

A first aspect according to the present disclosure provides an information processing apparatus including: an acquisition unit that acquires information indicating an event detected based on an image captured by an imaging apparatus; a determination unit that determines to start recording of the image when the event is detected at a first point of time, to continue the recording when the event is continuously detected within a first period from the first point of time, and to stop the recording when the event is continuously detected in a case of exceeding the first period from the first point of time; and a recording control unit that controls a start and an end of the recording based on a result determined by the determination unit.

A second aspect according to the present disclosure provides an information processing method including: acquiring information indicating an event detected based on an image captured by an imaging apparatus; and determining to start recording of the image when the event is detected at a first point of time, to continue the recording when the event is continuously detected within a first period from the first point of time, and to stop the recording when the event is continuously detected in a case of exceeding the first period from the first point of time.

A third aspect according to the present disclosure provides a program that causes an information processing apparatus to execute: a process of acquiring information indicating an event detected based on an image captured by an imaging apparatus; a process of determining to start recording of the image when the event is detected at a first point of time, to continue the recording when the event is continuously detected within a first period from the first point of time, and to stop the recording when the event is continuously detected in a case of exceeding the first period from the first point of time; and a process of controlling a start and an end of the recording based on a result determined by the determination unit.

A fourth aspect according to the present disclosure provides an information processing system including an imaging apparatus that captures an image and an information processing apparatus. In the information processing system, the information processing apparatus includes: an acquisition unit that acquires information indicating an event detected based on an image captured by an imaging apparatus; a determination unit that determines to start recording of the image when the event is detected at a first point of time, to continue the recording when the event is continuously detected within a first period from the first point of time, and to stop the recording when the event is continuously detected in a case of exceeding the first period from the first point of time; and a recording control unit that controls a start and an end of the recording based on a result determined by the determination unit.

### Advantageous Effect of Invention

According to one aspect, it is possible to appropriately reduce the volume of recording data.

### BRIEF DESCRIPTION OF DRAWINGS

FIG. 1 is a diagram showing an example of a configuration of an information processing apparatus according to an example embodiment;

FIG. 2 is a diagram showing a configuration example of an information processing system according to an example embodiment;

FIG. 3 is a diagram showing a hardware configuration example of an information processing apparatus according to an example embodiment;

FIG. 4 is a flowchart showing an example of processing of the information processing apparatus according to the example embodiment;

FIG. 5 is a diagram showing an example of an image captured by an imaging apparatus according to the example embodiment and an event detected based on the image;

FIG. 6 is a diagram showing an example of a period during which recording is continued according to the example embodiment;

FIG. 7 is a diagram showing an example of the period during which recording is continued according to the example embodiment;

FIG. 8 is a diagram showing an example of the period during which recording is continued according to the example embodiment;

FIG. 9 is a diagram showing an example of the period during which recording is continued according to the example embodiment; and

FIG. 10 is a diagram showing an example of setting an upper limit period for recording according to the example embodiment.

### EXAMPLE EMBODIMENTS

Principle of the present disclosure will be described with reference to some example embodiments. It is to be understood that these example embodiments are described only for the purpose of illustration and help those skilled in the art to understand and implement the present disclosure, without suggesting any limitations as to the scope of the present disclosure. The disclosure described herein can be implemented in various manners other than the following description.

In the following description and claims, unless defined otherwise, all technical and scientific terms used herein have the same meaning as commonly understood by one of ordinary skilled in the art to which the present disclosure belongs.

Example embodiments of the present invention will be described below with reference to the drawings.

### First Example Embodiment

### <Configuration>

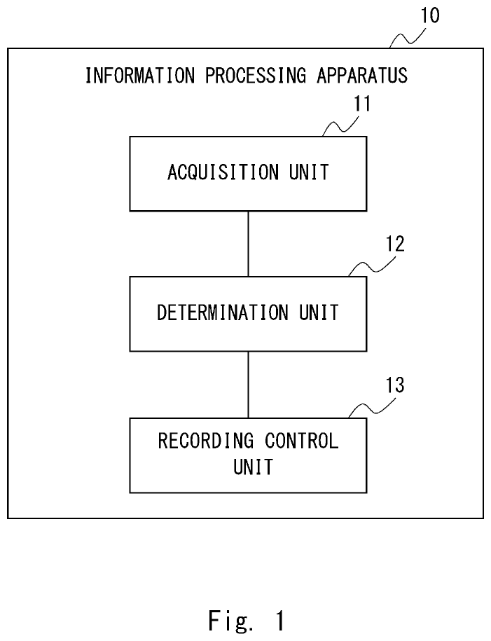

A configuration of an information processing apparatus 10 according to an example embodiment will be described with reference to FIG. 1. FIG. 1 is a diagram showing an example of the configuration of the information processing apparatus 10 according to the example embodiment. The information processing apparatus 10 includes an acquisition unit 11, a determination unit 12, and a recording control unit 13. These components may be implemented by cooperation between one or more programs installed in the information processing apparatus 10 and hardware such as a processor 101 and a memory 102 of the information processing apparatus 10.

The acquisition unit 11 acquires various kinds of information from a storage unit inside the information processing apparatus 10 or an external apparatus. The acquisition unit 11 acquires information indicating an event detected based on an image captured by an imaging apparatus 20, for example. In this case, the acquisition unit 11 may detect an event based on the image captured by the imaging apparatus 20 and acquire information about the event. Further, the acquisition unit 11 may acquire information about an event detected by another module inside the information processing apparatus 10 or by the external apparatus.

The determination unit 12 performs various determinations on recording of the image captured by the imaging apparatus 20, based on the information acquired by the acquisition unit 11. The “image” of the present disclosure includes at least one of a moving image and a still image. The determination unit 12 determines to start recording of an image when an event is detected at a first point of time, for example. Further, the determination unit 12 determines to continue the recording when the event is continuously detected within an upper limit period for recording from the first point of time, for example. Further, the determination unit 12 determines to stop the recording when the event is continuously detected in a case of exceeding the upper limit period for recording from the first point of time, for example.

The recording control unit 13 performs various kinds of control related to recording (storing) of an image captured by the imaging apparatus 20 based on a result determined by the determination unit 12. The recording control unit 13 controls a start and an end of recording based on the result determined by the determination unit 12, for example. The recording control unit 13 may cause a storage unit (recording unit) in the information processing apparatus 10 to store the image captured by the imaging apparatus 20, or may cause a recording unit of an external apparatus to record the image.

### Second Example Embodiment

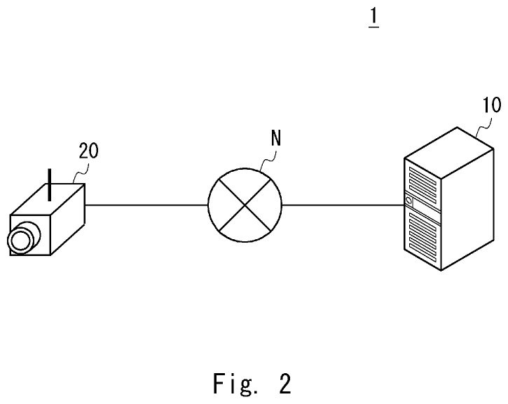

A configuration of an information processing system 1 according to an example embodiment will be described below with reference to FIG. 2.

### <Configuration of System>

FIG. 2 is a diagram showing a configuration example of the information processing system 1 according to the example embodiment. In FIG. 2, the information processing system 1 includes an information processing apparatus 10 and an imaging apparatus 20. In the example of FIG. 2, the information processing apparatus 10 and the imaging apparatus 20 are connected so as to be communicable with each other via a network N. The number of the information processing apparatuses 10 and the number of the imaging apparatuses 20 are not limited to the example in FIG. 2.

Examples of the network N include the Internet, a mobile communication system, a wireless LAN (Local Area Network), a LAN, a bus, and the like. Examples of the mobile communication system include a fifth generation mobile communication system (5G), a fourth generation mobile communication system (4G), a third generation mobile communication system (3G), and the like.

The information processing apparatus 10 is a device such as a server, a cloud, a personal computer, a recording apparatus, a network video recorder, or a smartphone. The information processing apparatus 10 records (records, saves) the image captured by the imaging apparatus 20.

The imaging apparatus 20 is a device such as a network camera, a camera, or a smartphone. The imaging apparatus 20 captures an image using a camera, and outputs (transmits) the captured image to the information processing apparatus 10.

### <Hardware Configuration>

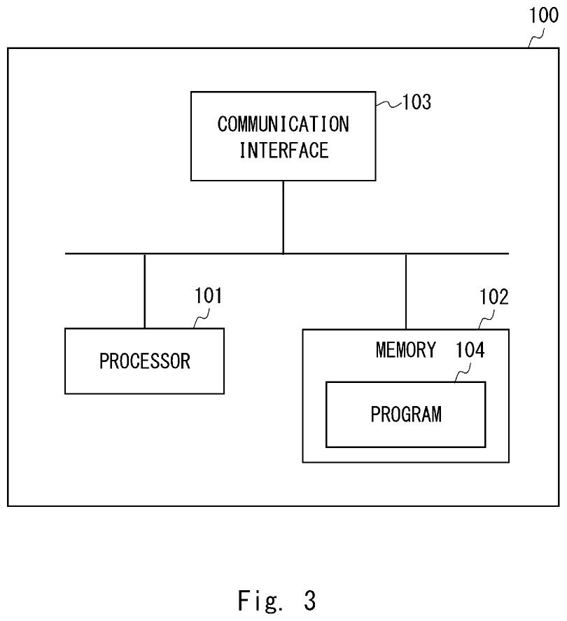

FIG. 3 is a diagram showing a hardware configuration example of the information processing apparatus 10 according to the example embodiment. In the example of FIG. 3, the information processing apparatus 10 (computer 100) includes a processor 101, a memory 102, and a communication interface 103. These components may be connected via a bus, for example. The memory 102 stores at least a portion of a program 104. The communication interface 103 includes interfaces necessary for communication with other network elements.

When the program 104 is executed by cooperation of the processor 101 and the memory 102, the computer 100 performs at least a part of the processes of the example embodiment of the present disclosure. The memory 102 may be of any type suitable for a local technical network. The memory 102 may be, as a non-limiting example, a non-transitory computer readable storage medium. Further, the memory 102 may be implemented using any suitable data storage technology, such as semiconductor-based memory devices, magnetic memory devices and systems, optical memory devices and systems, fixed memories and removable memories, and the like. Although only one memory 102 is shown in the computer 100, there may be several physically different memory modules in the computer 100. The processor 101 may be of any type. The processor 101 may include one or more of general purpose computers, special purpose computers, microprocessors, digital signal processors (DSPs), and processors based on multicore processor architecture, as non-limiting examples. The computer 100 may have multiple processors, such as application specific integrated circuit chips that are temporally dependent on a clock which synchronizes the main processor.

Example embodiments of the present disclosure may be implemented in hardware or dedicated circuits, software, logic, or any combination thereof. Some aspects may be implemented in hardware, while other aspects may be implemented in firmware or software which may be executed by a controller, a microprocessor, or another computing device.

The present disclosure also provides at least one computer program product tangibly stored on a non-transitory computer readable storage medium. The computer program product includes computer-executable instructions, such as those included in program modules, being executed in a device on a target real or virtual processor, to perform a process or a method of the present disclosure. The program modules include routines, programs, libraries, objects, classes, components, data structures, or the like that execute particular tasks or implement particular abstract data types. The functionality of the program modules may be combined or split between program modules as desired in various example embodiments. Machine-executable instructions for program modules may be executed within a local or a distributed device. In the distributed device, program modules may be located in both local and remote storage media.

Program code for executing a method of the present disclosure may be written in any combination of one or more programming languages. These program codes may be provided to a processor or a controller of a general purpose computer, a special purpose computer, or another programmable data processing apparatus. When the program code is executed by the processor or the controller, the functions/operations in a flowchart and/or block diagrams to be implemented are executed. The program code may execute entirely on a machine, partly on the machine, as a stand-alone software package, partly on the machine, and partly on a remote machine, or entirely on the remote machine or a server.

The program may be stored and supplied to a computer using various types of non-transitory computer readable media. The non-transitory computer readable media include various types of tangible storage media. Examples of the non-transitory computer readable media include a magnetic recording medium, a magneto-optic recording medium, an optical disk medium, a semiconductor memory, and the like. Examples of the magnetic recording medium include a flexible disk, a magnetic tape, a hard disk drive, and the like. Examples of the magneto-optic recording medium include a magneto-optic disk and the like. Exampled of the optical disk medium include a Blu-ray disc, a CD (Compact Disc)-ROM (Read Only Memory), a CD-R (Recordable), a CD-RW (ReWritable), and the like. Examples of the semiconductor memory include a solid state drive, a mask ROM, a PROM (Programmable ROM), an EPROM (Erasable PROM), a flash ROM, a RAM (Random Access Memory), and the like. These programs may be supplied to computers using various types of transitory computer readable media. Examples of the transitory computer readable media include an electrical signal, an optical signal, and an electromagnetic wave. The transitory computer readable media can supply programs to a computer through a wired communication line, for example, electric wires and optical fibers, or a wireless communication line.

### <Processing>

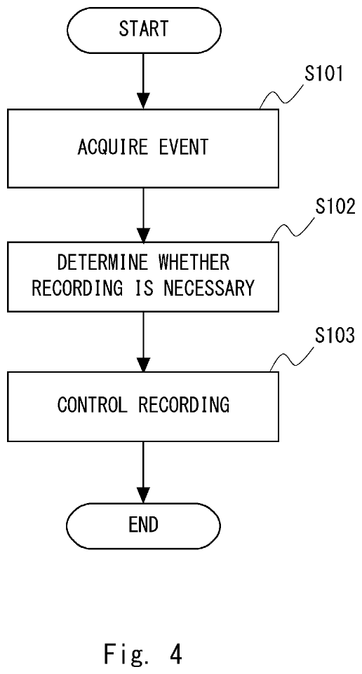

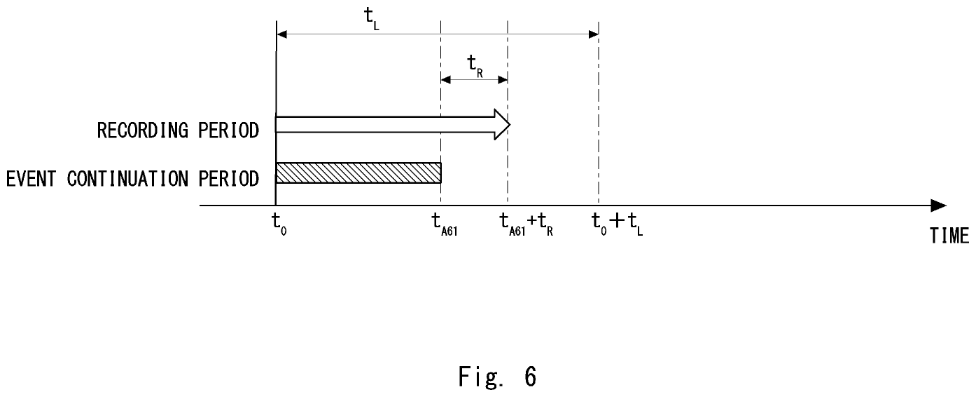

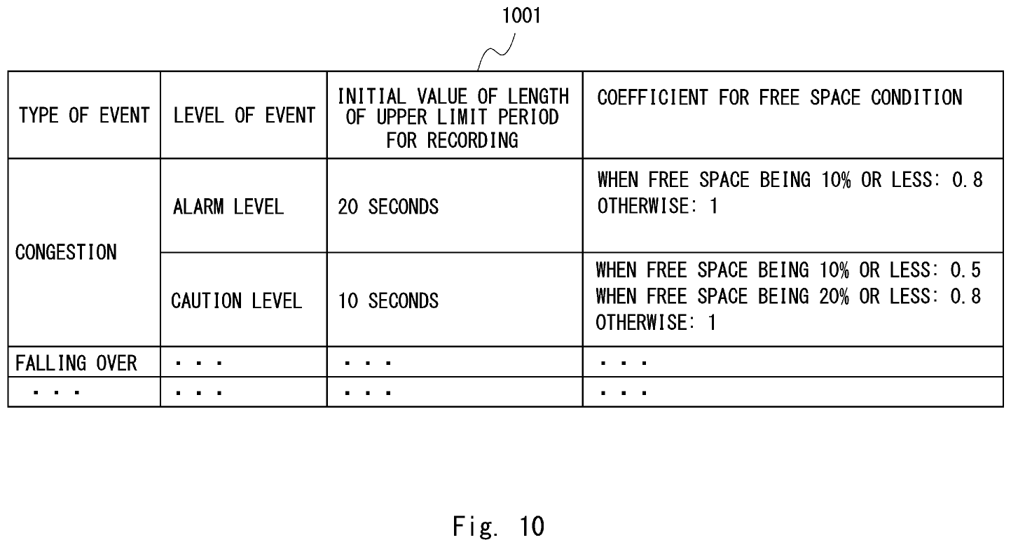

An example of processing of the information processing apparatus 10 according to the example embodiment will be described below with reference to FIGS. 4 to 10. FIG. 4 is a flowchart showing an example of processing of the information processing apparatus 10 according to the example embodiment. FIG. is a diagram showing an image captured by the imaging apparatus 20 according to the example embodiment and an event detected based on the image. FIGS. 6 to 9 are diagrams showing examples of periods during which recording is continued according to the example embodiment. FIG. 10 is a diagram showing an example of setting an upper limit period for recording according to the example embodiment.

The information processing apparatus 10 tracks, based on positions, moving directions, moving speeds, and features (for example, surface colors and heights) of persons in frames captured by the imaging apparatus 20 at points of time, positions and behavior of persons. Then, the information processing apparatus 10 executes the following process for each of the plurality of persons representing in the image captured by the imaging apparatus 20. Therefore, hereinafter, any one of the plurality of persons representing in the image captured by the imaging apparatus 20 is also referred to as a “person to be determined” as appropriate.

In step S1, the acquisition unit 11 of the information processing apparatus acquires information indicating an event (alert) detected based on the image captured by the imaging apparatus 20. A process of detecting the event may be performed by any of the information processing apparatus 10, the imaging apparatus 20, and the external apparatus, for example.

An example of the information indicating the event may include information indicating a type (content) of event, a region in the image where the event occurs, and a level (degree, alertness, importance, or necessity of recording) of the event. An example of the type of event may include congestion due to crowds. In addition, examples of the type of event may include falling over, crouching, coughing, sneezing, and non-wearing of a mask of a person (pedestrian, attendance, visitor). In this case, the information indicating the event may include, for example, information for identifying a person related to the event.

The information indicating the region in the image where the event occurs may include, for example, information indicating a range of pixels in the region in the image captured by the imaging apparatus 20. In this case, the information indicating the region in the image where the event occurs may include, for example, information indicating a pixel position at an upper left corner in the region, a length in a vertical direction (the number of pixels in the vertical direction), and a length in a horizontal direction.

Regarding the level of the event, for example, in the case where the type of event is congestion due to crowds, when the number of persons existing in a predetermined region in the image captured by the imaging apparatus 20 is equal to or greater than a first threshold, a first level (alarm level) may be set. Further, when the number of persons is less than the first threshold and equal to or greater than a second threshold, a second level (caution level) may be set.

For example, in the case where the type of event is falling over of a pedestrian, when AI (Artificial Intelligence) or the like determines that the pedestrian hits his/her head, the first level (alarm level) may be set.

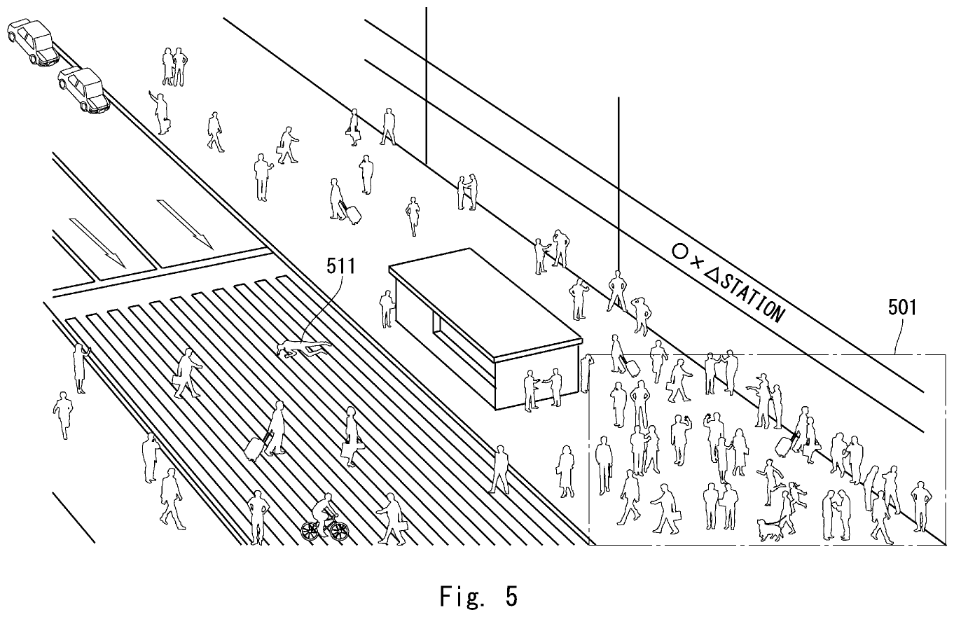

In the example of FIG. 5, an event of congestion is detected in a region 501 in an image 500 captured by the imaging apparatus 20. Further, an event of falling over of a person 511 is detected.

Subsequently, the determination unit 12 of the information processing apparatus 10 determines whether recording is necessary (step S2). Here, as shown in FIGS. 6 to 8, the determination unit 12 determines to start recording of an image when an event is detected at a first point of time to. The point of time to is a point of time when the event is newly detected instead of being continued from before.

In addition, as shown in FIGS. 6 to 8, the determination unit 12 determines to continue recording when the event is continuously detected within an upper limit period for recording t₁, from the first point of time t₀. FIG. 6 shows an example in which the period during which the event is continuously detected (event continuation period) is from the first point of time t₀ to a point of time t_{A61} within the upper limit period for recording t_{L}. In this case, as shown in FIG. 6, the determination unit 12 determines to continue the recording until a predetermined period t_{R} elapses from the point of time t_{A61} when the event is no longer detected (when the event is last detected) (from the first point of time t₀ to a point of time t_{A61}+t_{R}).

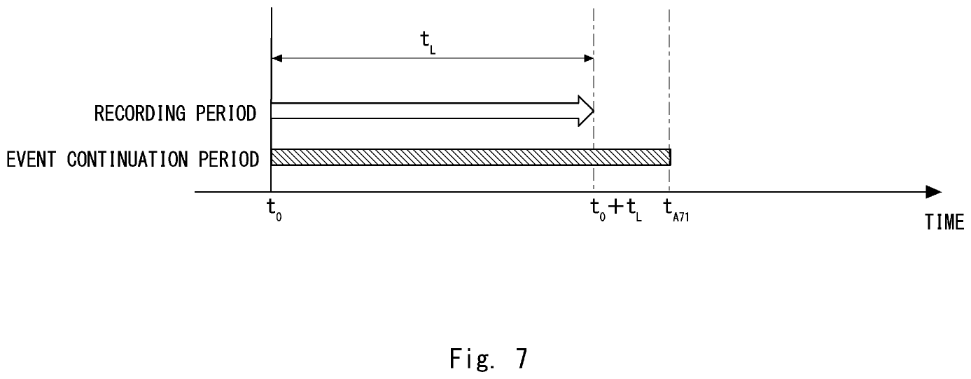

Further, the determination unit 12 determines to stop the recording when the event is continuously detected in a case of exceeding the upper limit period for recording t₁, from the first point of time to, for example. Thus, for example, an increase in the volume of recording data can be appropriately reduced. FIG. 7 shows an example in which the event continuation period is from the first point of time t₀ to a certain point of time t_{A71}, which is later than the upper limit period for recording t_{L}. In this case, as shown in FIG. 7, the determination unit 12 determines to continue the recording from the first point of time t₀ to a point of time until the upper limit period for recording t₁, elapses (from the first point of time t₀ to a point of time to +t_{L}). Then, the determination unit 12 determines to stop the recording at the point of time to +t₁, when the upper limit period for recording t₁, elapses.

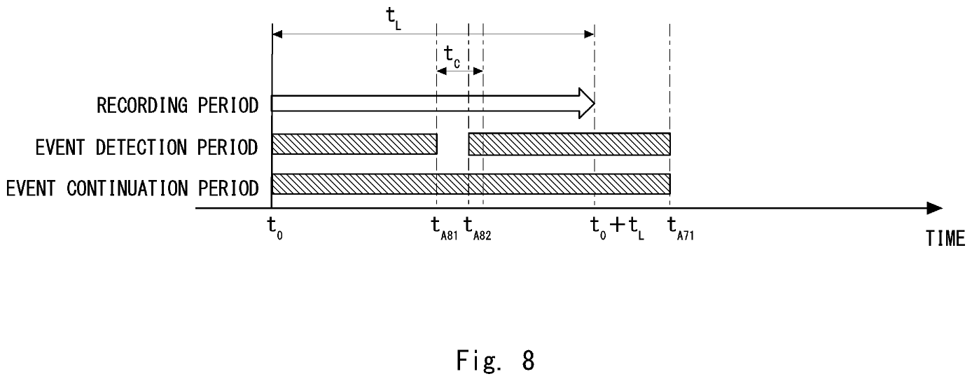

Further, as shown in FIG. 8, when the event is no longer detected at a second point of time t_{A81} and is then detected at a third point of time t_{A82} within a predetermined time t_{c} (hereinafter, also referred to as “event continuation determination time”. For example, 2 seconds) from the second point of time, the determination unit 12 determines that the event is also continuously detected between the second point of time t_{A81} and the third point of time t_{A82}. Therefore, even in the example of FIG. 8, the event continuation period is determined to be from the first point of time t₀ to a certain point of time t_{A71}, which is later than the upper limit period for recording t_{L}, as in FIG. 7, and the recording is stopped at the point of time t₀+t₁, when the upper limit period for recording t₁, elapses. Thus, for example, even when the person who is fallen over cannot be captured temporarily due to crossing of other pedestrians and vehicles in front of the person who is fallen over, the recording can be continued.

### (Example of Determining Event Continuation Determination Time)

The determination unit 12 may determine, based on predetermined conditions, the event continuation determination time. Thus, it is possible to more appropriately determine whether the event continues, for example. Examples of the predetermined conditions will be described below. The determination unit 12 may determine the event continuation determination time by combining a plurality of conditions below.

### ((Example of Determining Based on Surrounding Circumstances of Person))

The determination unit 12 may determine the event continuation determination time, based on surrounding circumstances of the person to be determined, which is determined based on an image captured by the imaging apparatus 20. In this case, the determination unit 12 may determine the event continuation determination time, based on the degree of congestion around the person to be determined, for example. In this case, the determination unit 12 may determine that the greater the number of persons and moving objects (for example, vehicles) existing in the surrounding (for example, an image region of a predetermined range including a region in which the person is captured) of the person to be determined, the higher the degree of congestion around the person to be determined, for example. Then, the determination unit 12 may determine the event continuation determination time to be longer as the degree of congestion is higher. Thus, for example, even when the surrounding of a certain person is congested like the region 501 in FIG. 5 and thus the person is frequently hidden behind other persons or moving objects moving toward a front side (front side as viewed from the imaging apparatus 20), it is possible to more appropriately determine whether the event continues.

((Example of Determining Based on at Least One of Time when Image is Captured and Place where Image is Captured))

In addition, the determination unit 12 may determine the event continuation determination time, based on at least one of a time when the image is captured by the imaging apparatus 20 and a place where the image is captured by the imaging apparatus 20. In this case, when the time at which the image is captured by the imaging apparatus 20 is within a predetermined period of time, the determination unit 12 may determine the event continuation determination time to be relatively long. Thus, for example, even in a period of time in a morning in busy due to commuting and in a period of time in an evening in busy due to returning home, it is possible to more appropriately determine whether the event continues.

Further, the determination unit 12 may determine initial values of the event continuation determination time according to the imaging apparatus 20. Each of the initial values may be set in the information processing apparatus 10 in advance for each of one or more imaging apparatuses 20. Thus, when the behavior of the person is detected based on the image captured by the imaging apparatus 20 that captures a station square with a relatively high degree of congestion, it is possible to more appropriately determine whether the event continues even when a total period during which the behavior of the person to be determined cannot be detected becomes relatively long.

### ((Example of Determining Based on Type of Object in Front of Person))

In addition, the determination unit 12 may determine the event continuation determination time, based on a type of an object in front of the person to be determined (front side as viewed from the imaging apparatus 20) in the image captured by the imaging apparatus 20. In this case, when the type of the object in front is a person and a vehicle, the determination unit 12 may determine that the length of the event continuation determination time is a first period length. Further, when the type of the object in front is a bus and a trolley, the determination unit 12 may determine that the length of the event continuation determination time is a second period length longer than the first period length. Thus, for example, even when the person to be determined is not captured for a long time due to the bus or the road trolley, it is possible to more appropriately determine whether the event continues.

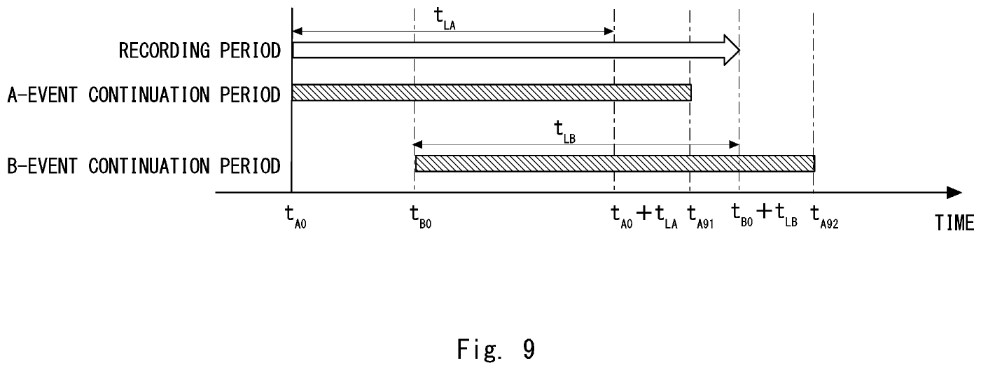

FIG. 9 shows an example in which another event is continuously detected while a certain event is continuously detected. As shown in FIG. 9, the determination unit 12 starts recording of an image when a first event is detected at a first point of time t_{A0}, as in the cases of FIGS. 6 to 8. Then, when a second event different in type from the first event is detected at a third point of time t_{B0} within a first upper limit period for recording t_{LA}, the determination unit 12 continues recording even when the first event is continuously detected at a point of time t_{A0}+t_{LA} in a case of exceeding the first upper limit period for recording t_{LA} from the first point of time t_{A0}, for example. Then, the determination unit 12 stops the recording at a point of time t_{B0}+t_{LB} when the second upper limit period for recording t_{LB} elapses from the third point of time t_{B0} at which the second event is newly detected. Thus, for example, when “falling over” is detected while “congestion” is continuously detected, it is possible to reduce (prevent) the recording from being stopped due to the elapse of the upper limit period for recording of “congestion”.

### (Example of Determining Upper Limit Period for Recording)

The determination unit 12 may determine the upper limit period for recording (length of the upper limit period for recording), based on at least one of the type of event, the level of the event, and a free space on the recording unit (for example, hard disk drive) for recording the image captured by the imaging apparatus 20. In this case, the length of the upper limit period for recording may be registered in the information processing apparatus 10 in association with conditions related to the type of the event, the level of the event, and the free space on the recording unit by the operator (administrator), as shown in FIG. 10. In an example of setting data 1001 in FIG. 10, an initial value of the length of the upper limit period for recording and a coefficient for the free space condition are recorded in association with a set of the type of the event and the level of the event.

The example of FIG. 10 indicates that the length of the upper limit period for recording in a case of “congestion” of an “alarm level” is determined to be 16 (=20×0.8) seconds when the free space is 10% or less of the recording capacity on the recording unit, and is determined to be 20 seconds, which is an initial value, when not being 10% or less. The example of FIG. 10 indicates that the length of the upper limit period for recording in a case of “congestion” of a “caution level” is determined to be 5 (=10×0.5) seconds when the free space is 10% or less, is determined to be 8 (=10×0.8) seconds when being 20% or less, and is determined to be 10 seconds, which is an initial value, when not being 20% or less. The case where the free space is 10% or less of the recording capacity on the recording unit means, for example, a case where the free space is 100 GB (gigabyte) or less when the recording capacity is 1 TB (terabyte).

Further, the determination unit 12 may determine, based on the region of the image in which the event is detected, a region to be recorded among the regions of the image. Then, the determination unit 12 may determine the length of the upper limit period for recording based on resolution (screen resolution, total number of pixels) of the region to be recorded. Thus, for example, an increase in the volume of recording data can be appropriately reduced. In this case, when the resolution of the region to be recorded is an initial value (for example, 4 K (QFHD, Quad Full High Definition): 3840×2160 pixels), the determination unit 12 may determine that the length of the upper limit period for recording is the initial value (for example, 20 seconds). Then, when the resolution of the region to be recorded is a value (for example, full HD (Full High Definition): 1920×1080 pixels) smaller than the initial value, the determination unit 12 may determine that the length of the upper limit period for recording is a time (for example, 80 seconds) longer than the initial value.

Further, the determination unit 12 may determine an image quality including at least one of the resolution and the frame rate at the time of recording the image, based on the type of event. Then, the determination unit 12 may determine the length of the upper limit period for recording based on the determined image quality. Thus, for example, an increase in the volume of recording data can be appropriately reduced. In this case, for example, when the type of event is “congestion”, the determination unit 12 may determine that the image quality is first resolution (for example, full HD) and a first frame rate (for example, 60 fps). Then, the determination unit 12 may determine that the length of the upper limit period for recording is the initial value (for example, 20 seconds). Further, for example, when the type of event is “falling over”, the determination unit 12 may determine that the image quality is second resolution (for example, 4 K) higher than the first resolution and a second frame rate (for example, 30 fps) lower than the first frame rate (for example, 60 fps). Then, the determination unit 12 may determine that the length of the upper limit period for recording is half (for example, 10 seconds) of the initial value.

In addition, when the type of event is at least one of falling over, crouching, sneezing, coughing, and non-wearing of a mask of a person, the determination unit 12 may change the length of the upper limit period for recording based on a front image of the person's face being recorded. In this case, first, the determination unit 12 uses AI or the like to determine whether the front image of the person's face is recorded by recording during the upper limit period for recording. Then, when the front image of the person's face is recorded, the determination unit 12 stops the recording in the case of exceeding the upper limit period for recording. Further, when the front image of the person's face is not recorded, the determination unit 12 continues the recording in the case of exceeding the upper limit period for recording. In this case, for example, when the front image of the person's face has not yet been recorded in the case of exceeding the upper limit period for recording, the determination unit 12 extends the upper limit period for recording by a predetermined time (for example, 10 seconds).

Subsequently, the recording control unit 13 of the information processing apparatus 10 controls recording (step S3). Here, in a case of recording on an external recording apparatus, the recording control unit 13 may transmit a command for controlling a start and an end of the recording to the external recording apparatus or the imaging apparatus 20.

### <Modification>

The information processing apparatus 10 may be an apparatus contained in one housing, but the information processing apparatus 10 of the present disclosure is not limited thereto. Each of the components of the information processing apparatus 10 may be implemented by cloud computing configured by one or more computers, for example. Further, the information processing apparatus 10 and the imaging apparatus 20 are housed in the same housing, and may be configured as an integrated information processing apparatus. Further, at least part of the processing of each functional unit of the information processing apparatus 10 may be executed by the imaging apparatus 20. Such an information processing apparatus 10 is also included in an example of the “information processing apparatus” of the present disclosure.

The present invention is not limited to the above-described example embodiments, and can be modified as appropriate without departing from the scope and spirit of the invention.

Some or all of the above-described example embodiments may also be described as in the following Supplementary Notes, but are not limited to the following.

### (Supplementary Note 1)

An information processing apparatus including: acquisition means for acquiring information indicating an event detected based on an image captured by an imaging apparatus;
determination means for determining to start recording of the image when the event is detected at a first point of time, to continue the recording when the event is continuously detected within a first period from the first point of time, and to stop the recording when the event is continuously detected in a case of exceeding the first period from the first point of time; and
recording control means for controlling a start and an end of the recording based on a result determined by the determination means.

### (Supplementary Note 2)

In the information processing apparatus according to Supplementary Note 1, when the event is no longer detected at a second point of time and is then detected at a third point of time within a predetermined time from the second point of time, the determination means determines that the event is continuously detected between the second point of time and the third point of time.

### (Supplementary Note 3)

In the information processing apparatus according to Supplementary Note 1 or 2, the event includes a first event and a second event different in type from the first event, and
when the second event is detected at a third point of time within the first period from the first point of time, the determination means determines to continue the recording even when the first event is continuously detected in the case of exceeding the first period from the first point of time.

### (Supplementary Note 4)

In the information processing apparatus according to any one of Supplementary Notes 1 to 3, the determination means determines a length of the first period based on at least one of a type of the event, a level of the event in the image, and a free space on recording means for recording the image.

### (Supplementary Note 5)

In the information processing apparatus according to any one of Supplementary Notes 1 to 4, the determination means determines, based on a region of the image detected by the event, a region to be recorded in the region of the image, and determines a length of the first period based on resolution of the region to be recorded.

### (Supplementary Note 6)

In the information processing apparatus according to any one of Supplementary Notes 1 to 5, the determination means determines, based on a type of the event, an image quality including at least one of resolution and a frame rate at the time of recording the image, and determines a length of the first period based on the image quality.

### (Supplementary Note 7)

In the information processing apparatus according to Supplementary Note 6, the determination means
determines that the image quality is first resolution and a first frame rate when a type of the event indicates congestion, and
determines that the image quality is second resolution higher than the first resolution and a second frame rate lower than the first frame rate when a type of the event indicates at least one of falling over, crouching, sneezing, coughing, and non-wearing of a mask of a person.

### (Supplementary Note 8)

In the information processing apparatus according to any one of Supplementary Notes 1 to 7, when a type of the event is a type of event indicating at least one of falling over, crouching, sneezing, coughing, and non-wearing of a mask of a person, the determination means
determines to stop the recording in the case of exceeding the first period from the first point of time when an image of a front face of the person is recorded, and
determines to continue the recording in the case of exceeding the first period from the first point of time when the image of the front face of the person is not recorded.

### (Supplementary Note 9)

An information processing method including:
acquiring information indicating an event detected based on an image captured by an imaging apparatus; and
determining to start recording of the image when the event is detected at a first point of time, to continue the recording when the event is continuously detected within a first period from the first point of time, and to stop the recording when the event is continuously detected in a case of exceeding the first period from the first point of time.

### (Supplementary Note 10)

A non-transitory computer-readable medium storing a program that causes an information processing apparatus to execute:
a process of acquiring information indicating an event detected based on an image captured by an imaging apparatus;
a process of determining to start recording of the image when the event is detected at a first point of time, to continue the recording when the event is continuously detected within a first period from the first point of time, and to stop the recording when the event is continuously detected in a case of exceeding the first period from the first point of time; and
a process of controlling a start and an end of the recording based on a result determined in the process of determining.

### (Supplementary Note 11)

An information processing system including:
an imaging apparatus that captures an image and an information processing apparatus,
the information processing apparatus including:
acquisition means for acquiring information indicating an event detected based on an image captured by the imaging apparatus;
determination means for determining to start recording of the image when the event is detected at a first point of time, to continue the recording when the event is continuously detected within a first period from the first point of time, and to stop the recording when the event is continuously detected in a case of exceeding the first period from the first point of time; and
recording control means for controlling a start and an end of the recording based on a result determined by the determination means.

### (Supplementary Note 12)

In the information processing system according to Supplementary Note 11, when the event is no longer detected at a second point of time and is then detected at a third point of time within a predetermined time from the second point of time, the determination means determines that the event is continuously detected between the second point of time and the third point of time.

This application is based upon and claims the benefit of priority from Japanese Patent Application No. 2021-056702, filed on Mar. 30, 2021, the entire contents of which are incorporated herein by reference.

### REFERENCE SIGNS LIST

1 INFORMATION PROCESSING SYSTEM
10 INFORMATION PROCESSING APPARATUS
11 ACQUISITION UNIT
12 DETERMINATION UNIT
13 RECORDING CONTROL UNIT
20 IMAGING APPARATUS

What is claimed is:

1. An information processing apparatus comprising:
at least one memory storing instructions, and
at least one processor configured to execute the instructions to;
acquire information indicating an event detected based on an image captured by an imaging apparatus;
determine to start recording of the image when the event is detected at a first point of time, to continue the recording when the event is continuously detected within a first period from the first point of time, and to stop the recording when the event is continuously detected in a case of exceeding the first period from the first point of time; and
control a start and an end of the recording based on a result of the determination.

2. The information processing apparatus according to claim 1, wherein when the event is no longer detected at a second point of time and is then detected at a third point of time within a predetermined time from the second point of time, the at least one processor determines that the event is continuously detected between the second point of time and the third point of time.

3. The information processing apparatus according to claim 1, wherein
the event includes a first event and a second event different in type from the first event, and
when the second event is detected at a third point of time within the first period from the first point of time, the at least one processor determines to continue the recording even when the first event is continuously detected in the case of exceeding the first period from the first point of time.

4. The information processing apparatus according to claim 1, wherein the at least one processor determines a length of the first period based on at least one of a type of the event, a level of the event in the image, and a free space on recording unit for recording the image.

5. The information processing apparatus according to claim 1, wherein the at least one processor determines, based on a region of the image detected by the event, a region to be recorded in the region of the image, and determines a length of the first period based on resolution of the region to be recorded.

6. The information processing apparatus according to claim 1, wherein the at least one processor determines, based on a type of the event, an image quality including at least one of resolution and a frame rate at the time of recording the image, and determines a length of the first period based on the image quality.

7. The information processing apparatus according to claim 6, wherein the at least one processor
determines that the image quality is first resolution and a first frame rate when a type of the event indicates congestion, and
determines that the image quality is second resolution higher than the first resolution and a second frame rate lower than the first frame rate when a type of the event indicates at least one of falling over, crouching, sneezing, coughing, and non-wearing of a mask of a person.

8. The information processing apparatus according to claim 1, wherein when a type of the event is a type of event indicating at least one of falling over, crouching, sneezing, coughing, and non-wearing of a mask of a person, the at least one processor
determines to stop the recording in the case of exceeding the first period from the first point of time when an image of a front face of the person is recorded, and
determines to continue the recording in the case of exceeding the first period from the first point of time when the image of the front face of the person is not recorded.

9. An information processing method comprising:
acquiring information indicating an event detected based on an image captured by an imaging apparatus; and
determining to start recording of the image when the event is detected at a first point of time, to continue the recording when the event is continuously detected within a first period from the first point of time, and to stop the recording when the event is continuously detected in a case of exceeding the first period from the first point of time.

10. A non-transitory computer-readable medium storing a program that causes an information processing apparatus to execute:
a process of acquiring information indicating an event detected based on an image captured by an imaging apparatus;
a process of determining to start recording of the image when the event is detected at a first point of time, to continue the recording when the event is continuously detected within a first period from the first point of time, and to stop the recording when the event is continuously detected in a case of exceeding the first period from the first point of time; and
a process of controlling a start and an end of the recording based on a result determined in the process of determining.

11.-12. (canceled)

13. The information processing method according to claim 9, wherein when the event is no longer detected at a second point of time and is then detected at a third point of time within a predetermined time from the second point of time, the determining determines that the event is continuously detected between the second point of time and the third point of time.

14. The information processing method according to claim 9, wherein
the event includes a first event and a second event different in type from the first event, and
when the second event is detected at a third point of time within the first period from the first point of time, the determining determines to continue the recording even when the first event is continuously detected in the case of exceeding the first period from the first point of time.

15. The information processing method according to claim 9, wherein the determining determines a length of the first period based on at least one of a type of the event, a level of the event in the image, and a free space on recording unit for recording the image.

16. The information processing method according to claim 9, wherein the determining determines, based on a region of the image detected by the event, a region to be recorded in the region of the image, and determines a length of the first period based on resolution of the region to be recorded.

17. The information processing method according to claim 9, wherein the determining determines, based on a type of the event, an image quality including at least one of resolution and a frame rate at the time of recording the image, and determines a length of the first period based on the image quality.

18. The non-transitory computer-readable medium according to claim 10, wherein when the event is no longer detected at a second point of time and is then detected at a third point of time within a predetermined time from the second point of time, the process of determining determines that the event is continuously detected between the second point of time and the third point of time.

19. The non-transitory computer-readable medium according to claim 10, wherein
the event includes a first event and a second event different in type from the first event, and
when the second event is detected at a third point of time within the first period from the first point of time, the process of determining determines to continue the recording even when the first event is continuously detected in the case of exceeding the first period from the first point of time.

20. The non-transitory computer-readable medium according to claim 10, wherein the process of determining determines a length of the first period based on at least one of a type of the event, a level of the event in the image, and a free space on recording unit for recording the image.

21. The non-transitory computer-readable medium according to claim 10, wherein the process of determining determines, based on a region of the image detected by the event, a region to be recorded in the region of the image, and determines a length of the first period based on resolution of the region to be recorded.

22. The non-transitory computer-readable medium according to claim 10, wherein the process of determining determines, based on a type of the event, an image quality including at least one of resolution and a frame rate at the time of recording the image, and determines a length of the first period based on the image quality.
